(19) United States
(12) Patent Application Publication
(10) Pub. No.: US 2015/0242226 A1
(43) Pub. Date: Aug. 27, 2015

(54) METHODS AND SYSTEMS FOR CALCULATING COSTS OF VIRTUAL PROCESSING UNITS

(71) Applicant: VMWARE, INC., Palo Alto, CA (US)

(72) Inventors: AMARNATH PALAVALLI, Bangalore (IN); KUMAR GAURAV, Bangalore (IN); PIYUSH BHARAT MASRANI, Bangalore (IN); DATTATHREYA SATHYAMURTHY, Bangalore (IN); GUY GINZBURG, Herzliya (IL)

(73) Assignee: VMWARE, INC., Palo Alto, CA (US)

(21) Appl. No.: 14/261,459

(22) Filed: Apr. 25, 2014

(30) Foreign Application Priority Data
Feb. 22, 2014 (IN) 884/CHE/2014

(51) Int. Cl. G06F 9/455

(52) U.S. Cl. CPC G06F 9/45533

(57) ABSTRACT

This disclosure presents computational systems and methods for calculating the cost of vCPUs from the cost of CPU computing cycles. In one aspect, a total number of computing cycles used by one or more virtual machines (“VMs”) is calculated based on utilization measurements of a multi-core processor for each VM over a period of time. The method also calculates a total number of virtual CPUs (“vCPUs”) used by the one or more VMs based on vCPU counts for each VM over the period of time. A cost per vCPU is calculated based on the total number of computing cycles, the total number of vCPUs, and cost per computing cycle. The cost per vCPU is stored in a data-storage device. The cost per vCPU can be used to calculate the cost of a VM that uses one or more of the vCPUs.

### RELATED APPLICATIONS

Benefit is claimed under 35 U.S.C. 119(a)-(d) to Foreign application Serial No. 884/CHE/2014 filed in India entitled “METHODS AND SYSTEMS FOR CALCULATING COSTS OF VIRTUAL PROCESSING UNITS”, filed on Feb. 22, 2014, by VMware, Inc., which is herein incorporated in its entirety by reference for all purposes.

### TECHNICAL FIELD

The present disclosure is directed to methods and systems for calculating the cost of virtual machine central processors.

### BACKGROUND

A data center is a facility that houses servers and mass data-storage devices and other associated components including backup power supplies, redundant data communications connections, environmental controls, such as air conditioning and fire suppression, and includes various security systems. A data center is typically maintained by an IT service provider. An enterprise purchases data storage and data processing services from the provider in order to run applications that handle core business and operational data for the enterprise. The applications may be proprietary for the enterprise to use exclusively or for public use.

In recent years, virtual machines (“VMs”) have been introduced to lower data center capital investment in facilities and operational expenses and reduce energy consumption. A VM is a software implementation of a computer that executes application software just like a physical computer. VMs have the advantage of not being bound to physical resources, which allows VMs to be moved around and scaled up or down to meet changing computational demands of an enterprise without affecting a user's experience. As a result, enterprises run applications on VMs that may, in turn, be run on any number of various servers and use other data center components. Because the VMs may be spread over various hardware components, assessing the cost of IT services provided to an enterprise may be difficult to determine. Although the cost of using particular hardware used per unit time may be determined directly from monitoring hardware usage, determining the cost of using the VMs is difficult to determine and predict because VMs can be scaled up and down and run on many different servers. Enterprises that purchase IT services and IT service providers seek methods and systems for calculating and predicting the cost of VMs.

### SUMMARY

This disclosure describes computational systems and methods for calculating cost of vCPUs from the cost of a CPU computing cycle. In one aspect, a total number of computing cycles used by one or more virtual machines (“VMs”) is calculated based on utilization measurements of a multi-core processor for each VM over a period of time. The method also calculates a total number of virtual CPUs (“vCPUs”) used by the one or more VMs based on vCPU counts for each VM over the period of time. A cost per vCPU is calculated based on the total number of computing cycles, the total number of vCPUs, and cost per computing cycle. The cost per vCPU is stored in a data-storage device. Once the cost per vCPU is determined, the cost of a VM that uses one or more of the vCPUs can be calculated.

### DESCRIPTION OF THE DRAWINGS

FIG. 1 shows an example of a generalized computer system that executes methods for determining cost virtual central processing units (“vCPUs”).

FIG. 2 shows an example of three rows of cabinets in a data center.

FIG. 3 shows a top view of an example multi-core processor.

FIG. 4 shows an example assignment of vCPUs to cores of a multi-core processor with no hyper threading available.

FIG. 5 shows an example assignment of vCPUs to cores of a multi-core processor with hyperthreading available.

FIG. 6 shows an example of a virtual machine (“VM”) assignments in time intervals over a period of time.

FIG. 7 shows a bar graph of VM utilization.

FIG. 8 shows a bar graph of vCPU counts.

FIG. 9 shows bar graphs of VM utilization for four VMs over time intervals.

FIG. 10 shows bar graphs of vCPU counts for four VMs over time intervals.

FIG. 11 shows a table of example VM utilizations for eight example VMs.

FIG. 12 shows an example of VM assignments.

FIG. 13 shows a plot of a time-dependent weighting factor.

FIG. 14 shows a flow-control diagram of a method for determining a cost per vCPU.

### DETAILED DESCRIPTION

Although the types of server processors and server configurations may vary within a data center, the cost of using each server and server hardware can be determined. Server-cost models may be used to calculate the monthly cost of each server which, in turn, may be used to calculate amortized cost of CPU usage per month (GHz/month), RAM usage per month (GB/month), and storage usage per month (GB/month). But the configuration of a VM at provisioning time is measured in terms of virtual CPU (“vCPU”) counts and not in units of CPU usage, such as GHz. Because there is no direct correlation between processing with vCPUs and processing with physical CPUs, an IT service provider and a data-center user cannot accurately determine or predict the cost of using a VM. This disclosure presents systems and methods for calculating the cost of a vCPU from the cost of CPU computing cycles. Once the cost per vCPU is determined, the cost of a VM that uses one or more of the vCPUs can be calculated.

It should be noted at the onset that data related to optimizing content in a UI is not, in any sense, abstract or intangible. Instead, the data is necessarily digitally encoded and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems on electronically or magnetically stored data, with the results of the data processing and data analysis digitally encoded and stored in one or more tangible, physical, data-storage devices and media.

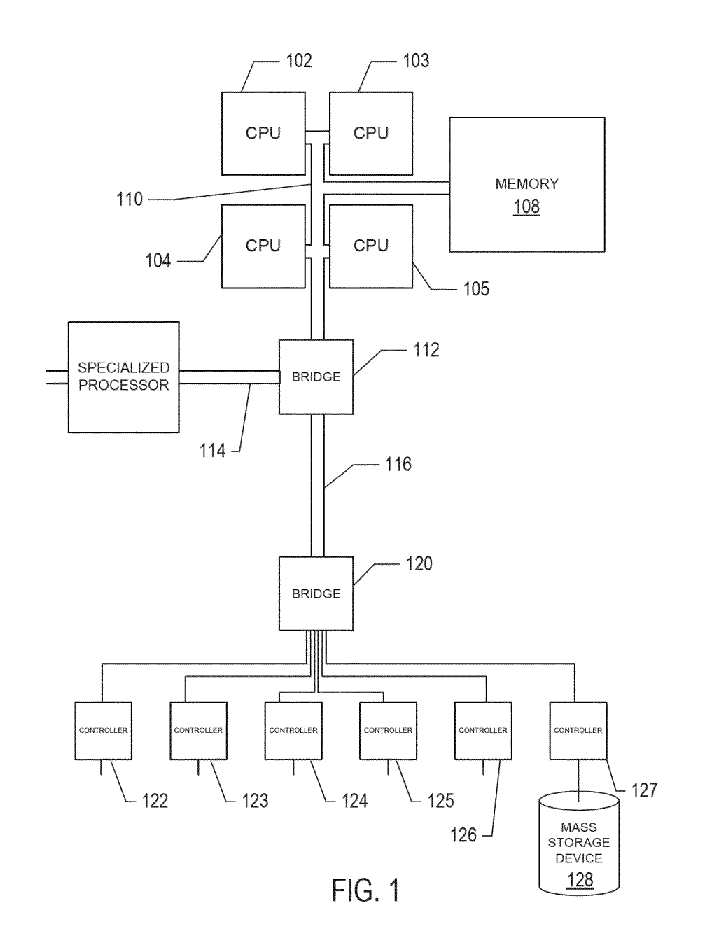

FIG. 1 shows an example of a generalized computer system that executes efficient methods for calculating the cost of vCPUs and therefore represents a data-processing system. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. The busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of computer-readable media, such as computer-readable medium 128, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 128 is a data-storage device, including electronic memory, optical or magnetic disk drive, USB drive, flash memory and other such data-storage device. The computer-readable medium 128 can be used to store machine-readable instructions that encode the computational methods described below and can be used to store encoded data, during store operations, and from which encoded data can be retrieved, during read operations, by computer systems, data-storage systems, and peripheral devices.

Data centers house computer equipment, telecommunications equipment, and data-storage devices. A typical data center may occupy one room of a building, one or more floors of a building, or may occupy an entire building. Most of the computer equipment is in the form of servers stored in cabinets arranged in rows with corridors between rows of cabinets in order to allow access to the front and rear of each cabinet.

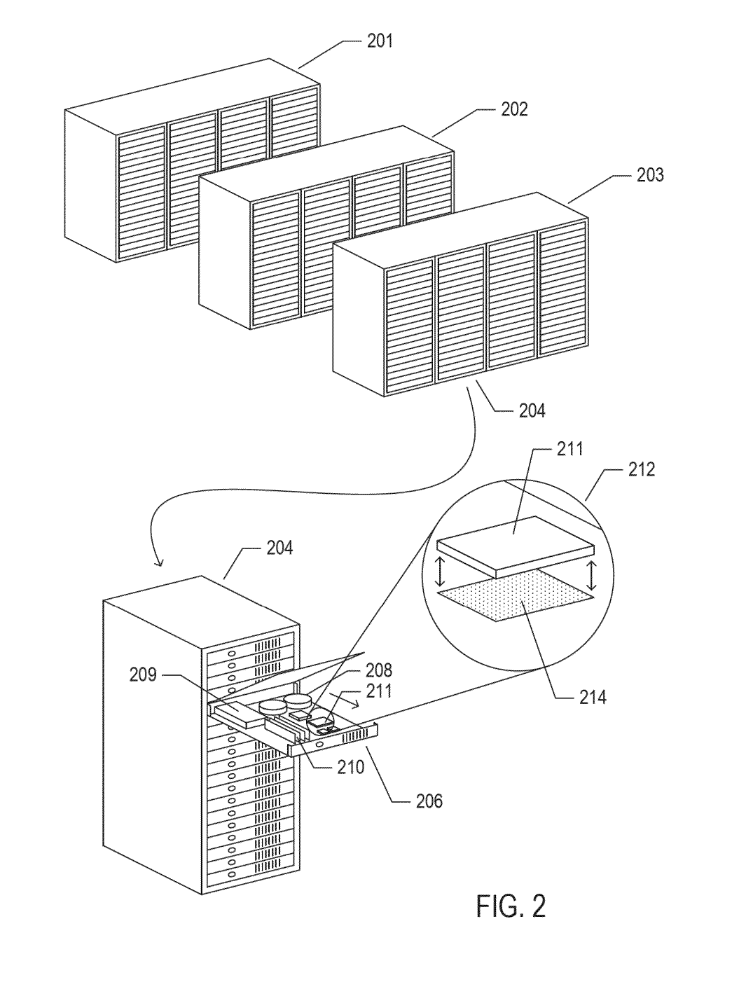

FIG. 2 shows an example of three rows of cabinets 201-203 in a data center. Each row includes four cabinets, such as cabinet 204, of vertically stacked boards. Each board is located on a tray that may be pulled out in order to access board components. A number of the boards may be configured as servers and other boards may be dedicated to telecommunications and/or configured with data-storage devices, such as hard disk drives, for storing and accessing large quantities of data. A server is composed of software and computer hardware arranged on a circuit board that is disposed on a tray of a cabinet. Each server is a host for one or more software applications that are used in a network environment. In the example of FIG. 2, the cabinet 204 is shown enlarged with a tray 206 pulled out from the cabinet 204 to access hardware components of a server. In this example, the server hardware components include a cooling system 208, data storage 209, memory 210, a processor 211, and any number of other electronic components. FIG. 2 includes an exploded, magnified view 212 of the processor 211 unplugged from a socket 214 located in a circuit board 216. The processor 211 is a single computing component composed of a multiple independent processing units called “cores.” Each core plugs into a separate socket within the larger socket 214. The server hardware is not limited to one multi-core processor. In other implementations, server hardware may be configured with more than one multi-core processor.

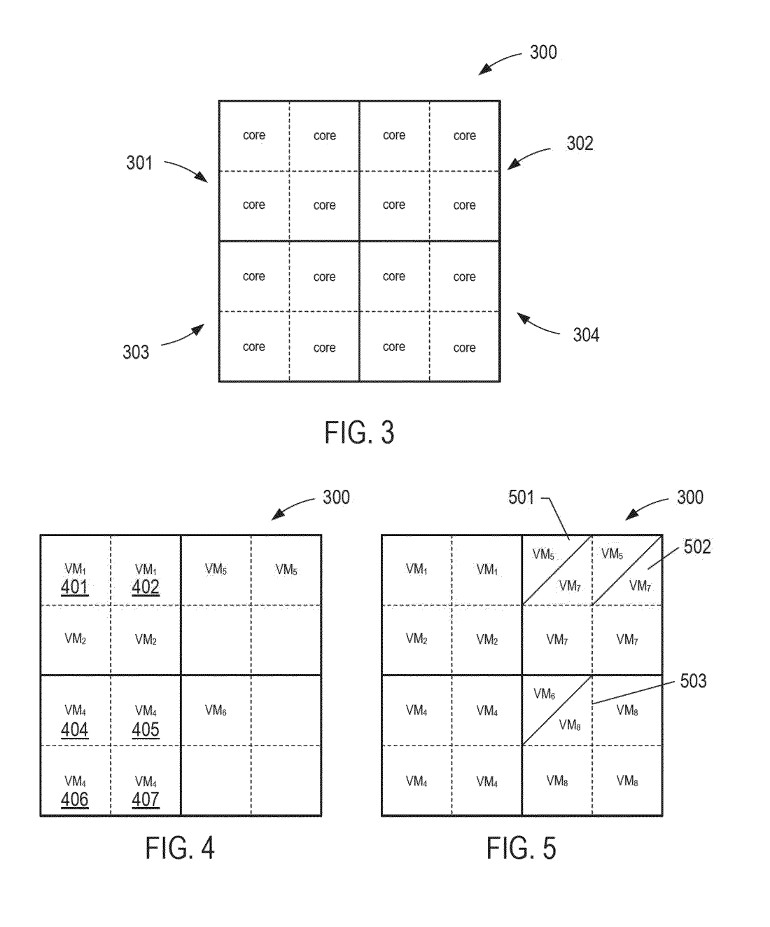

FIG. 3 shows a top view of an example multi-core processor 300. The processor 300 is the portion of the server hardware that carries out the instructions of a computer program and is the primary element that executes server hardware functions. In this example, the processor 300 contains 16 cores grouped into quadrants 301-304 with each quadrant composed of four cores. Each core is an independent processing unit that includes an L1 cache and functional units needed to run programs. The processor 300 may include a number of L2 caches and an L3 cache. Pairs of cores within each of the quadcores 301-304 may share an L2 cache and all 16 cores may share the L3 cache. The cores may independently run programs or threads. In certain implementations, a core may be configured to run one or more software threads at a time by multiplexing the functional units of the core between the software threads of different programs, as necessary. Such cores are called “dual” or “multithreaded cores” and the process of running two or more threads on cores of a multi-core processor is called “hyper threading.”

Methods for calculating the cost of vCPUs are now described for an example set of eight VMs denoted by VM₁, VM₂, VM₃, VM₄, VM₅, VM₆, VM₇, and VM₈ run on the 16-core processor 300. It should be note that methods are not intended to be limited to eight VMs run on a 16-core processor. In practice, methods for calculating the cost of vCPUs may be applied to servers that run any number of VMs configured with processors composed of any integer number of M cores. Each of the eight VMs is configured with a certain number of vCPUs. Table I displays an example number of vCPUs each of the eight VMs is configured with:

TABLE I

| VMs | Configuration of vCPUs |
|---|---|
| VM₁ | 2 |
| VM₂ | 2 |
| VM₃ | 4 |
| VM₄ | 4 |
| VM₅ | 2 |
| VM₆ | 1 |
| VM₇ | 4 |
| VM₈ | 4 |

Table I reveals how the VMs behave like computers with each VM allocated with a particular number of vCPUs. Each vCPU of a VM is a virtual processor that may be regarded as a physical processor unit. For example, virtual machine VM₁ operates like a computer with two processors. The server includes computer software called a “hypervisor” that controls how the vCPUs are assigned to the 16 cores of the processor 300. Hypervisor assigns each vCPU to a core for an interval of computational time. Each allocation of the vCPUs depends on how the VMs are configured and whether or not the processor 300 allows for hyper threading.

FIG. 4 shows an example assignment of vCPUs to cores of the processor 300 with no hyper threading available. In this example, the processor 300 does not allow for hyper threading or hypervisor has turned “off” hyper threading functionality. In a particular time interval, hypervisor has selected VM₁, VM₂, VM₄, VM₅, and VM₆ to run on the processor 300. For example, VM₁ is configured with two vCPUs assigned to run on cores 401 and 402 and VM₄ is configured with four vCPUs assigned to run on cores 404-407. Because VM₃, VM₇, and VM₈ each require four cores to run on the processor 300 and hyper threading is not available and there are not enough cores available for this particular selection of VMs, hypervisors stalls VM₃, VM₇, and VMs to run in a later computation time interval.

FIG. 5 shows an example assignment of vCPUs to cores of the processor 300 with hyper threading available. In this example, the processor 300 allows for hyper threading and hyper threading functionality is turned “on.” Hypervisor has selected all eight of the VMs to run on the processor 300 with cores 501-503 selected to run threads from different applications. For example, the cores 501 and 502 are selected to run software threads from a first program running on VMs and software threads run on VM₇. Core 503 is selected to run software threads from a third program run on VM₆ and software threads from a fourth program run on VMs.

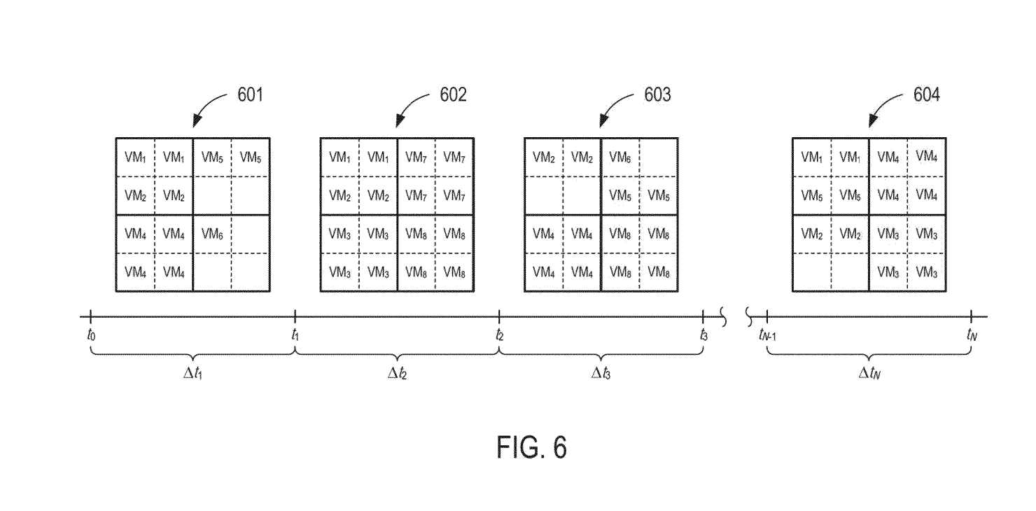

Hypervisor selects particular subsets of VMs to run during time intervals. In particular, hypervisor manages and prioritizes the VMs to run based on the number of vCPUs and CPU share configured for individual VMs. Users may change the configuration selected by hypervisor, but scheduling which VMs are run in the time intervals is controlled by hypervisor. The decision to run a particular VM on the processor 300 may be determined by the available cores, whether the processor allows hyper threading, and the priority level hypervisor assigns to each VM. FIG. 6 shows an example of VM assignments for four of N time intervals. Boxes 601-604 represent vCPU assignments to the 16 cores of the processor 300 for four separate computational time intervals. The computational time intervals are denoted by Δt=tⱼ−tⱼ₋₁, where interval index j is an integer ranging from 0 to N. Time intervals may be on the order of milliseconds. Alternatively, the duration of the time intervals may be based on an average CPU utilization metric. This is the statistics collection collection interval and examples of suitable time intervals may be on the order of 1 minute, 2 minutes, 5 minutes, 30 minutes, 2 hours, and 24 hours. Longer interval values may be determined when granular time interval details are not available. For example one may compute 5 minutes statistics by aggregating the 1 minute statistics. For each time interval, the cores operate as processor units for the VMs according to how the vCPUs are assigned to particular cores. For example, in time interval Δt₁, box 601 represents an assignment of vCPUs of VM₁, VM₂, VM₄, VM₅, and VM₆ to the cores as described above with reference to FIG. 4. In time interval Δt₂, box 602 represents an assignment of vCPUs of VM₁, VM₂, VM₃, VM₇, and VM₇ to the cores, and in time interval Δt₃, box 603 represents an assignment of vCPUs of VM₂, VM₄, VM₅, VM₆, and VMs to the cores. The example of FIG. 6 demonstrates how hypervisor changes VMs and vCPU assignments from one time interval to the next. For each time interval Δtⱼ, the maximum number of compute cycles is given by:

TCCⱼ=NCⱼ·CS·Δtⱼ (1)

where
CS is core processor speed (e.g., number of computer cycles per second in GHz); and
NCⱼ is the number of assigned cores in the time interval Δtⱼ.

Methods for determining the cost of a vCPU are based on VM utilization and vCPU counts calculated during each time interval Δtⱼ. Consider first a time-dependent function that represents a measure of VM utilization given by:

VMᵢ(tⱼ) (2)

where subscript i is a VM integer index.

VM utilization, VMᵢ(tⱼ), is die total number of compute cycles executed by the VMᵢ in the time interval Δtⱼ. Note that 0≦VMᵢ(tⱼ)≦NCⱼ·CS, where NCⱼ·CS is the maximum number of compute cycles without processing stalls during the time interval Δtⱼ. VM utilization is computed as an aggregation of utilization statistics collected over a statistics interval, such as a one minute time interval. An example of a processing stall occurs when a VMᵢ is idle while waiting for input/output operations to be completed. The durations of the processing stalls may be different from time interval to time interval. As a result, it may be the case that 0≦VMᵢ(tⱼ)<NCⱼ·CS and VMᵢ(tⱼ)*VMᵢ(tⱼ), where j≠k.

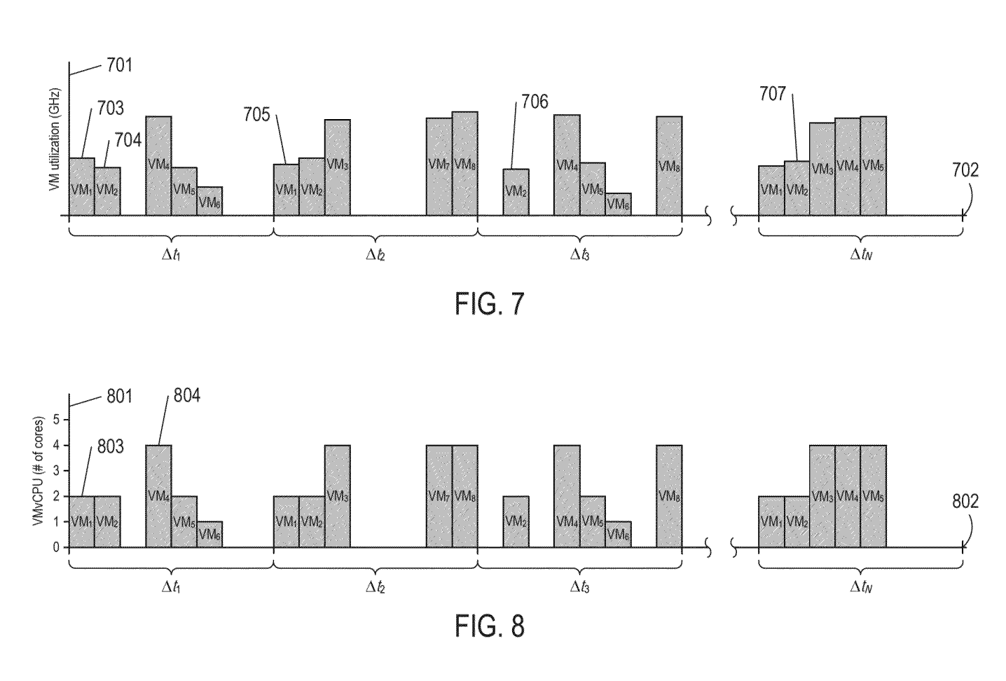

FIG. 7 shows a bar graph of VM utilization for the vCPU assignment in the time intervals represented in FIG. 6. Vertical axis 701 represents cycles per unit time in GHz, and horizontal axis 702 represents time. Bars represent VM utilization in compute cycles per GHz for the eight VMs. For example, in time interval Δt₁, bar 703 represents the total number of compute cycles in GHz for VM₁ denoted by VM₁(t₁) and bar 704 represents the total number of compute cycles in GHz for VM₂ denoted by VM₂(t₁). Note that for unassigned VMs in a time interval, the total number of compute cycles in GHz is zero. For example, VM₃ is not assigned in time interval Δt₁ as indicated in FIG. 6 and as a result VM₃(t₁)=0. Bars 704-707 for VM₂ are all of different heights in the time intervals Δt₁, Δt₂, Δt₃, and Δt_{N}, respectively, which is an example of how the number of compute cycles for the VM₂ varies from time interval to time interval (i.e., VM₂(t₁)≠VM₂(t₂)≠VM₂(t₃)≠VM₂(t_{N})).

Next, consider vCPU counts of each of the VMs in each time interval given by:

VMvCPUᵢ(tⱼ) (3)

FIG. 8 shows a bar graph of vCPU counts, VMvCPUᵢ(tⱼ), for assignment of vCPUs associated with the VMs in the time intervals represented in FIG. 6. Vertical axis 801 represents vCPU counts, and horizontal axis 802 represents time. Bars represent vCPU counts for each of the eight VMs and correspond to the vCPU assignments represented in FIG. 6. In other words, the height of each bar corresponds to the number of vCPUs assigned during a time interval. For example, bar 803 indicates that VM₁ is assigned two vCPUs in the time interval Δt₁, and bar 804 indicates that VM₄ is assigned four vCPUs in the time interval Δt₁. In other words, VMvCPU₁(t₁)=2 and VMvCPU₄(t₁)=4. On the other hand, vCPU counts are zero for VMs with vCPUs that are not assigned in a time interval.

In one implementation of a method to determine the cost of vCPUs, the number of compute cycles over the N time intervals is calculated for each VM, as follows:

$${\sum }_{j = 1}^{N} {VM}_{i} ( {t}_{j} ) Δ {t}_{j} \qquad ( 4 )$$

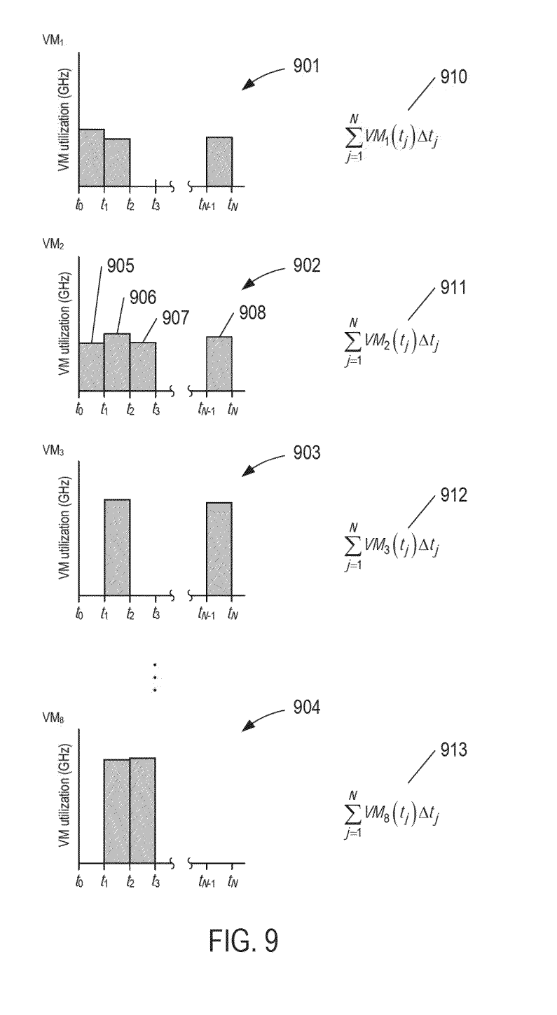

FIG. 9 shows separate bar graphs of VM utilization for four of the eight example VMs over the N time intervals. Bar graphs 901-904 represent VM utilization for VM₁, VM₂. VM₃, and VM_{N} over the N time intervals depicted in FIG. 7. For example, bars 905-908 in bar graph 902 represents VM₂ utilization in each of the N time intervals. The number of compute cycles for VM₁, VM₂, VM₃, and VM_{N} over a period of time from time t₀ to t_{N} are calculated according to the sums 910-913, respectively.

The number of compute cycles for each VM are summed to give a total number of computing cycles used by the VMs the period of time from t₀ to t_{N} as follows:

$$G ( T ) = {\sum }_{i = 1}^{M} {\sum }_{j = 1}^{N} {VM}_{i} ( {t}_{j} ) Δ {t}_{j} \qquad ( 5 )$$

where M is the number of VMs.

The number of virtual machines M may be any integer value greater than or equal to one. In the example above, M is equal to eight.

Next, the number of vCPUs used by each VMᵢ over the N time intervals is calculated as follows:

$${\sum }_{j = 1}^{N} {VMvCPU}_{i} ( {t}_{j} ) Δ {t}_{j} \qquad ( 6 )$$

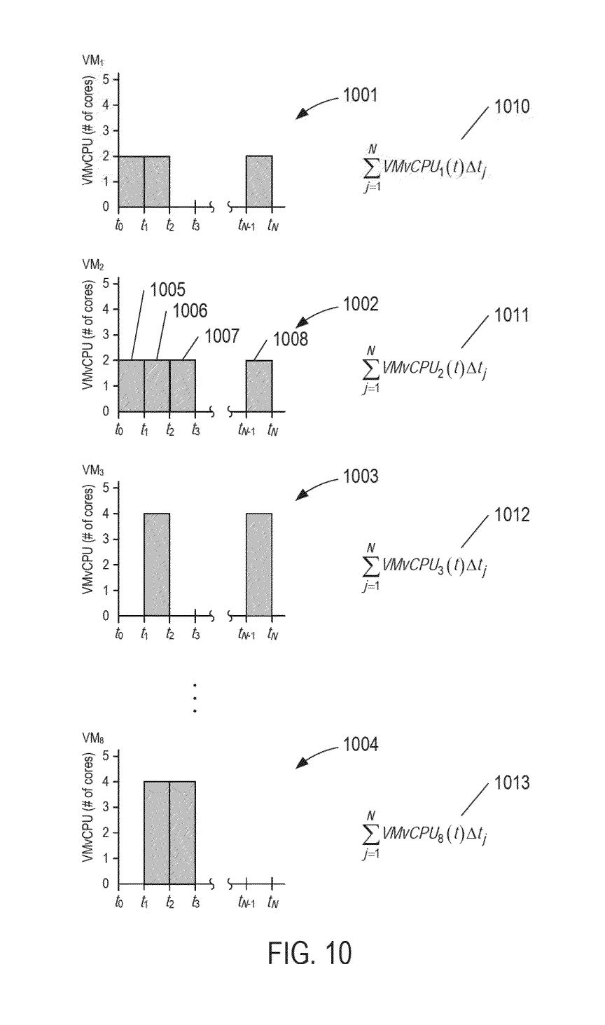

FIG. 10 shows separate bar graphs of vCPU counts for four of the eight example VMs over the N time intervals. Bar graphs 1001-1004 represent vCPU counts for VM₁. VM₂. VM₃, and VM_{N} over the N time intervals depicted in FIG. 8. For example, bars 1005-1008 in bar graph 1002 represent vCPU counts for VM₂ in each of the N time intervals. The vCPU counts for VM₁, VM₂. VM₃, and VM_{N} over the period of time from t₀ to time t_{N} are calculated according to the sums 1010-1013, respectively.

The number of vCPUs for each VM are summed to give a total number of vCPUs used by the VMs over the period of time from t₀ to t_{N} as follows:

$$C ( T ) = {\sum }_{i = 1}^{M} {\sum }_{j = 1}^{N} {VMvCPU}_{i} ( {t}_{j} ) Δ {t}_{j} \qquad ( 7 )$$

The total number of computing cycles used by the VMs G(T) (Equation 5) and the total number of vCPUs used by the VMs C(T) (Equation (7)) are used to determine a cost per vCPU as follows:

$${C}_{vCPU} = {C}_{comp} \cdot \frac{G ( T )}{C ( T )} \qquad ( 8 )$$

where C_{comp} is the cost per computing cycle.

For example, the cost per computing cycle C_{comp} may be in units of dollars per GHz (i.e., $/GHz).

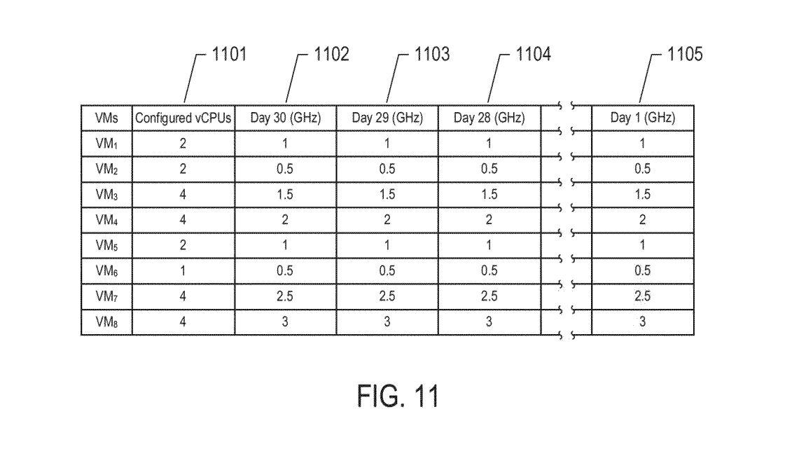

FIG. 11 shows a table of example VM utilizations for the eight example VMs used over 30 days. Column 1101 displays the vCPU configurations for each of the VMs described above. Columns 1102-1105 display VM utilization for each of the 30 days. The data displayed in the table 1100 provides a simple example of how Equations (5), (7), and (8) may be used to determine the cost per vCPU. In this example the time intervals are 1 day. According to Equation 5, the total number of computing cycles used by the eight VMs over 30 days is given by:

$$\begin{matrix}G ( T ) = {\sum }_{i = 1}^{8} {\sum }_{j = 1}^{30} {VM}_{i} ( {t}_{j} ) Δ {t}_{j} \\ = ( 1 + 0.5 + 1.5 + 2 + 1 + 0.5 + 2.5 + 3 ) \cdot 30 \\ = 360 GHz - days\end{matrix}$$

According to Equation 7, The total vCPU used by the VMs over 30 days is given by:

$$\begin{matrix}C ( T ) = {\sum }_{i = 1}^{8} {\sum }_{j = 1}^{30} {VMvCPU}_{i} ( {t}_{j} ) Δ {t}_{j} \\ = ( 2 + 2 + 4 + 4 + 2 + 1 + 4 + 4 ) \cdot 30 \\ = 690 vCPU - days\end{matrix}$$

Taking the cost per computing cycle C_{comp} as $30/GHz, Equation (8) gives the cost per vCPU as

$${C}_{vCPU} = {C}_{comp} \cdot \frac{G ( T )}{C ( T )} = \frac{\$30}{GHz} \cdot \frac{360 GHz - days}{690 vCPU - days} = \$15 .63 / vCPU$$

Now given the cost per vCPU at $15.63/vCPU, the cost of RAM at, for example, $3/GB, and the cost of storage at, for example, $0.30/GB/month, the cost for a VM configured with 2vCPU, 2 GB RAM and 20 GB storage is

2vCPU·$15.63/vCPU+2 GB·$3/GB+20 GB·$0.30/GB=$43.26

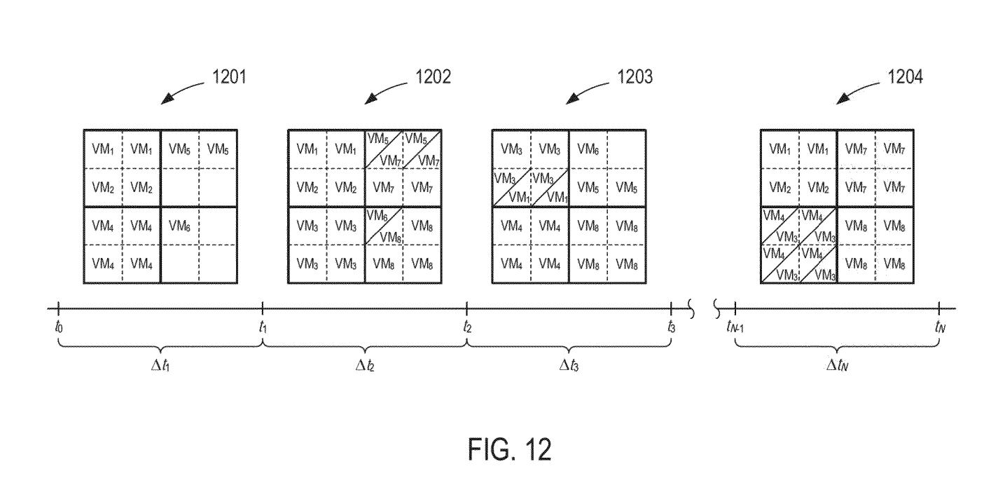

The implementations described above are not limited to a multi-core processor without hyper threading functionality or a multi-core processor with hyper threading turned “off.” Equations (2)-(8) may also be used to calculate the cost per vCPU for a multi-core processor with hyper threading turned “on.” FIG. 12 shows an example of VM assignments for four of N time intervals. Boxes 1201-1204 represent vCPU assignments to the 16 cores of the processor 300 for four separate time intervals with hyper threading turned “on.” For example, in time interval Δt₂, box 1202 represents the vCPU to core assignments described above with reference to FIG. 5, vCPU counts are recorded for each time interval even though the vCPUs associated with different VMs share the same core and VM utilization is measured for each of the VMs in each of the time intervals. For example, even though VM₆ and VM₈ share use of the same core, the vCPU of VM₆ is counted and the vCPU of VM₈ is counted, and VM utilizations VM₆(t₂) and VM₈(t₂) may be measured for VM₆ and VM₈ in the time interval Δt₂. As a result, Equation (5) can be used to calculate a total number of computing cycles used by the VMs over the period of time from t₀ to t_{N}. Equation (7) can be used to calculate the total number of vCPUs used by the VMs from time t₀ to time t_{N}, and Equation (8) can be used to calculate the cost per vCPU even though the vCPUs may share the cores.

Equation (5) used to calculate the total number of computing cycles used by the VMs and Equation (6) used to calculate the total number of vCPUs used by the VMs are un weighted with respect to time. In other implementations, Equations (5) and (6) may include a time-dependent weighting factor given by:

ρ^{t}^{_{N}}^{-t}^{ⱼ} (9)

where 0<ρ<1 and is selected by a user (e.g., ρ=0.95).

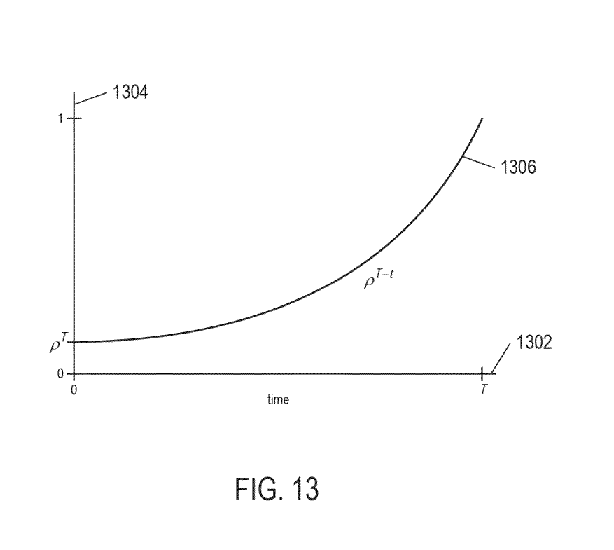

FIG. 13 shows a plot of a time-dependent weighting factor for t_{N}=T and tⱼ is any value between 0 and T represented by t. Horizontal axis 1302 represents time, vertical axis 1304 represents the value of the weighting factor, and curve 1306 represents the weighting factor. Curve 1306 reveals that the weighting factor places more weight on recent VM utilization and vCPU counts than on VM utilization and vCPU counts that occurred further back in time.

Equations (5) and (6) may be modified to include time-dependent weighting factors to give corresponding equations:

$$\begin{matrix}G ( T ) = {\sum }_{i = 1}^{M} {\sum }_{j = 1}^{N} {VM}_{i} ( {t}_{j} ) {ρ}_{1}^{{t}_{N} - {t}_{j}} Δ {t}_{j} & ( 10 ) \\ C ( T ) = {\sum }_{i = 1}^{M} {\sum }_{j = 1}^{N} {VMvCPU}_{i} ( {t}_{j} ) {ρ}_{2}^{{t}_{N} - {t}_{j}} Δ {t}_{j} & ( 11 )\end{matrix}$$

The weighted value for G(T) given in Equation (10) and the weighted value for C(T) given in Equation (11) may be used to calculate the cost per vCPU according to Equation (8). In certain implementations, ρ₁ and ρ₂ may be selected as different values, while in other implementations. ρ₁ and ρ₂ may be equal.

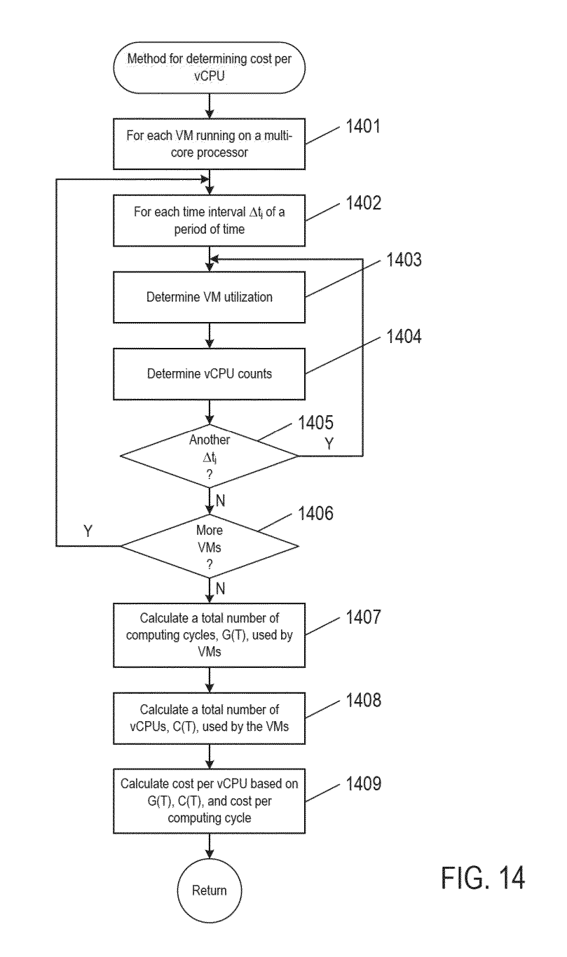

FIG. 14 shows a flow-control diagram of a method for determining a cost per vCPU. For-loop beginning in block 1401 repeats the operations of blocks 1402-1406 for each VM running on a multi-core processor. For-loop beginning in block 1402 repeats the operations of blocks 1403-1405 for each time interval Δtⱼ. Each VM is configured with one or more vCPUs as described above with reference to Table I. In block 1403, VM utilization, VMᵢ(tⱼ), is determined for the time interval and stored in the data-storage device. In block 1404, vCPU counts are collected for the time interval and stored in the data-storage device. In block 1405, when all of the time intervals in the period of time have been considered, control flows to block 1406, otherwise the operations in blocks 1403 and 1404 are repeated. In block 1406, when all of the VMs have been considered, control flows to block 1407, otherwise the operations in blocks 1402-1405 are repeated. In block 1407, a total number of computing cycles G(T) is calculated according to Equation (5) or according to Equation (10). In block 1408, a total number of vCPU counts is calculated according to Equation (7) or according to Equation (11). In block 1409, the cost per vCPU is calculated according to Equation (8).

Although various implementations have been described in terms of particular embodiments, it is not intended that the disclosure be limited to these embodiments. Modifications within the spirit of the disclosure will be apparent to those skilled in the art. For example, any of a variety of different implementations can be obtained by varying any of many different design and development parameters, including programming language, underlying operating system, modular organization, control structures, data structures, and other such design and development parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of die disclosure. Thus, the present disclosure is not intended to be limited to the embodiments shown herein but is to be accorded the widest scope consistent with the principles and novel features disclosed herein.

1. A system for determining cost per virtual processor unit for one or more virtual machines (“VMs”) run on a multi-core processor, the system comprising:
one or more processors;
one or more data-storage devices; and
a routine stored in the data-storage devices and executed using the one or more processors, the routine
calculating a total number of computing cycles used by the one or more VMs based on utilization measurements of the multi-core processor of each VM over a period of time;
calculating a total number of virtual processor units used by the one or more VMs based on a count of virtual processor units for each VM over the period of time;
calculating a cost per virtual processor unit based on the total number of computing cycles, the total number of virtual processors, and cost per computing cycle; and
storing the cost per virtual processor unit in a data-storage device.

2. The system of claim 1 wherein calculating the total number of computing cycles used by the one or more VMs over the period of time further comprises:
for each VM,
counting compute cycles of the multi-core processor within time intervals of the period of time to generate a VM utilization for each time interval;
summing a product of each VM utilization and duration of associated time interval over the period of time to generate a number of computing cycles; and
summing the number of computing cycles for each VM to generate the total number of computing cycles.

3. The system of claim 1 wherein calculating the total number of virtual processor units used by the one or more VMs over die period of time further comprises:
for each VM,
counting virtual processor units executed on the multi-core processor in each time interval of the period of time to generate a virtual processor unit count for each time interval;
summing a product of the virtual processor unit count and duration of associated time interval to generate a number a number of virtual processor units; and
summing the number of virtual processor unit counts for each VM to generate the total number of virtual processor units used by the VMs.

4. The system of claim 1 wherein calculating the cost per virtual processor unit further comprises:
dividing the total number of computing cycles used by each VM by the total number of virtual processor units used by the VMs to generate a ratio of the total number of computing cycles to the total number of virtual processor; and
multiplying the ration by the cost per computing cycle to generate the cost per virtual processor unit.

5. The system of claim 1 further comprises calculating a cost for a VM to be run on the server based on the cost per virtual processor unit, a cost of memory for the server, and a cost storage for the server.

6. The system of claim 1 wherein calculating the total number of computing cycles used by the one or more VMs further comprises calculating the total number of computing cycles with a time-dependent weighting factor that places more weight on later computing cycles than early computing cycles.

7. The system of claim 1 wherein calculating the total number of virtual processor units used by the one or more VMs further comprises calculating total number of virtual processor units with a time-dependent weighting factor that places more weight on later counted virtual processor units than early counted processor units.

8. A method stored in one or more data-storage devices and executed using one or more processors for determining cost per virtual processor unit for one or more virtual machines (“VMs”) run on a multi-core processor, the method comprising:
calculating a total number of computing cycles used by the one or more VMs based on utilization measurements of the multi-core processor of each VM over a period of time;
calculating a total number of virtual processor units used by the one or more VMs based on a count of virtual processor units for each VM over the period of time;
calculating a cost per virtual processor unit based on the total number of computing cycles, the total number of virtual processors, and cost per computing cycle; and
storing the cost per virtual processor unit in a data-storage device.

9. The method of claim 8 wherein calculating the total number of computing cycles used by the one or more VMs over the period of time further comprises:
for each VM,
counting compute cycles of the multi-core processor within time intervals of the period of time to generate a VM utilization for each time interval;
summing a product of each VM utilization and duration of associated time interval over the period of time to generate a number of computing cycles; and
summing the number of computing cycles for each VM to generate the total number of computing cycles.

10. The method of claim 8 wherein calculating the total number of virtual processor units used by the one or more VMs over the period of time further comprises:
for each VM,
counting virtual processor units executed on the multi-core processor in each time interval of the period of time to generate a virtual processor unit count for each time interval;
summing a product of the virtual processor unit count and duration of associated time interval to generate a number a number of virtual processor units; and
summing the number of virtual processor unit counts for each VM to generate the total number of virtual processor units used by the VMs.

11. The method of claim 8 wherein calculating the cost per virtual processor unit further comprises:
dividing the total number of computing cycles used by each VM by the total number of virtual processor units used by die VMs to generate a ratio of die total number of computing cycles to the total number of virtual processor; and
multiplying the ration by the cost per computing cycle to generate the cost per virtual processor unit.

12. The method of claim 8 further comprises calculating a cost for a VM to be run on the server based on the cost per virtual processor unit, a cost of memory for the server, and a cost storage for the server.

13. The method of claim 8 wherein calculating the total number of computing cycles used by the one or more VMs further comprises calculating the total number of computing cycles with a time-dependent weighting factor that places more weight on later computing cycles than early computing cycles.

14. The method of claim 8 wherein calculating the total number of virtual processor units used by the one or more VMs further comprises calculating total number of virtual processor units with a tune-dependent weighting factor that places more weight on later counted virtual processor units than early counted processor units.

15. A computer-readable medium encoded with machine-readable instructions that implement a method carried out by one or more processors of a computer system to perform the operations of
calculating a total number of computing cycles used by the one or more virtual machines (“VMs”) based on utilization measurements of the multi-core processor of each VM over a period of time;
calculating a total number of virtual processor units used by the one or more VMs based on a count of virtual processor units for each VM over the period of time:
calculating a cost per virtual processor unit based on the total number of computing cycles, the total number of virtual processors, and cost per computing cycle; and
storing the cost per virtual processor unit in a data-storage device.

16. The medium of claim 15 wherein calculating the total number of computing cycles used by the one or more VMs over the period of time further comprises:
for each VM,
counting compute cycles of the multi-core processor within time intervals of the period of time to generate a VM utilization for each time interval;
summing a product of each VM utilization and duration of associated time interval over the period of time to generate a number of computing cycles; and
summing the number of computing cycles for each VM to generate the total number of computing cycles.

17. The medium of claim 15 wherein calculating the total number of virtual processor units used by the one or more VMs over the period of time further comprises:
for each VM,
counting virtual processor units executed on the multi-core processor in each time interval of the period of time to generate a virtual processor unit count for each time interval;
summing a product of the virtual processor unit count and duration of associated time interval to generate a number a number of virtual processor units; and
summing the number of virtual processor unit counts for each VM to generate the total number of virtual processor units used by the VMs.

18. The medium of claim 15 wherein calculating the cost per virtual processor unit further comprises:
dividing the total number of computing cycles used by each VM by the total number of virtual processor units used by the VMs to generate a ratio of the total number of computing cycles to the total number of virtual processor; and
multiplying the ration by the cost per computing cycle to generate the cost per virtual processor unit.

19. The medium of claim 15 further comprises calculating a cost for a VM to be run on the server based on the cost per virtual processor unit, a cost of memory for the server, and a cost storage for the server.

20. The medium of claim 15 wherein calculating the total number of computing cycles used by the one or more VMs further comprises calculating the total number of computing cycles with a time-dependent weighting factor that places more weight on later computing cycles than early computing cycles.

21. The medium of claim 15 wherein calculating the total number of virtual processor units used by the one or more VMs further comprises calculating total number of virtual processor units with a time-dependent weighting factor that places more weight on later counted virtual processor units than early counted processor units.
